(19) United States
(12) Patent Application Publication
(10) Pub. No.: US 2009/0251819 A1
(43) Pub. Date: Oct. 8, 2009

(54) HARD DISK DRIVE AND METHOD OF SETTING A WRITE-VERIFY TEMPERATURE THEREOF

(75) Inventors: Sang Hun LEE, Anyang-si (KR); Myung II KIM, Seoul (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 12/417,821

(22) Filed: Apr. 3, 2009

(30) Foreign Application Priority Data
Apr. 4, 2008 (KR) 2008-31644

(51) Int. Cl. G11B 21/02

(52) U.S. Cl. 360/75; G9B/21.003

(57) ABSTRACT

A method of setting a write-verify temperature of a hard disk drive having at least one disk mapped into a plurality of zones and at least one head. The method can include measuring at least one parameter related to performance of the hard disk drive for each head and each zone, and setting a critical temperature to activate a write-verify function of each head and each zone based on the at least one parameter measured for each head and each zone.

### CROSS-REFERENCE TO RELATED APPLICATIONS

This application claims priority under 35 U.S.C. § 119(a) to Korean Patent Application No. 10-2008-0031644, filed on Apr. 4, 2008 in the Korean Intellectual Property Office, the disclosure of which is incorporated herein by reference in its entirety.

### BACKGROUND

1. Field of the Inventive Concept

The present general inventive concept relates to a hard disk drive (HDD) and a method of setting a write-verify temperature of the HDD, and more particularly, to an HDD which can minimize use of a write-verify function to satisfy reliability of a write operation of the HDD with minimal deterioration of performance, and a method of setting a write-verify temperature of the HDD.

2. Description of the Related Art

HDDs are data storage devices capable of recording data on a disk or reproducing data stored on the disk by changing digital electronic pulses including data information to a permanent magnetic field. HDDs are widely used as typical auxiliary memory devices of computer systems because of their fast access time to a large amount of data for recording or reproduction.

As HDDs have been developed with high TPI (tracks per inch) and a high BPI (bits per inch) of HDDs, an increase in the data storage capacity and a decrease in the size have been rapidly realized. Also, the application of the HDD has been expanded to laptops, MP3 players, mobile communication terminals, etc.

Recently, as the range of use of the HDD expands, a demand for using the HDD in a special environment or under extreme conditions is being increased. Accordingly, HDDs capable of operating in an extremely low or high temperature environment or HDDs that are highly vibration-resistant have been developed. For the HDD to perform a normal operation in the extreme environment, the HDD should have quite high reliability. A write-verify function is one of technologies to improve the reliability of the HDD.

The write-verify function is a data storage protection technology introduced to improve reliability of the HDD, that is, as a function to verify writing data to a disk. However, when an internal temperature of an HDD is under a predetermined critical temperature, for example, 0° C., performance of the HDD is deteriorated. Thus, in the operation of writing data to a disk in a low temperature mode in which the performance of the HDD is deteriorated, the write-verify function can delay the write operation since a data write command is received to write data to the disk and the written data is read from the disk to repeat data write and read operations according to an error rate by comparing the read data with the original data before the write operation is complete.

Although the write-verify function may improve the reliability of an HDD by verifying recording with respect to a disk, data transfer performance is necessarily deteriorated because the HDD should wait until a write point can be re-read to verify whether the write is correctly performed by re-reading the write point. Thus, to satisfy the performance of the HDD, a method of performing the minimum write-verify function while improving the reliability of the HDD is needed.

A conventional write-verify technology has a structure in which the maximum number of times the write-verify function is performed is limited on firmware operating the HDD in consideration of a transfer time, and is not separately set for each HDD. In addition, the write-verify function is only performed under a particular temperature. Thus, the write-verify function is uniformly set to all heads and zones of the same HDDs or the HDDs manufactured in the same period and using the same firmware.

In a conventional HDD employing the above method, performance may be degraded under a certain condition such as a low temperature because a temperature for activating the write-verify function is set regardless of the read and write performance of each HDD. Also, the conventional write-verify technology may have a negative impact on reliability of the HDD such that the HDD fails to meet a certain degree of reliability.

### SUMMARY

The present general inventive concept provides a hard disk drive (HDD) which can minimize use of a write-verify function to minimize deterioration of performance of the HDD while satisfying reliability of a write operation of the HDD, and a method of setting a write-verify temperature of the HDD.

Additional embodiments of the present general inventive concept will be set forth in part in the description which follows and, in part, will be obvious from the description, or may be learned by practice of the general inventive concept.

According to an embodiment of the present general inventive concept, there is provided a method of setting a write-verify temperature of a hard disk drive having at least one disk mapped into a plurality of zones and at least one head, the method can include measuring at least one parameter related to performance of the hard disk drive for each head and each zone, and setting a critical temperature to activate a write-verify function of each head and each zone based on the at least one parameter measured for each head and each zone.

The setting of a critical temperature may include assigning a performance level to each head and each zone according to a predetermined classification with respect to the at least one parameter measured for each head and each zone and setting the critical temperature corresponding to the performance level of each head and each zone.

In the setting of the critical temperature corresponding to the performance level of each head and each zone, the critical temperature may decrease as the performance level increases.

The at least one parameter may include a bit error rate (BER).

The at least one parameter may include read channel optimization (RCO) data.

The at least one parameter may include bits per inch (BPI).

The at least one parameter may be a plurality of parameters, and the plurality of parameters may include at least two of a bit error rate (BER), read channel optimization (RCO) data and bits per inch (BPI).

The at least one head may include a write head and a read head and, in the measuring of at least one parameter of each head and each zone, the performance of the hard disk drive may be a write performance of the write head.

The at least one head may include a write head and a read head and, in the measuring of at least one parameter of each head and each zone, the performance of the hard disk drive may be a write and read performance of the write head and the read head, respectively.

The method may be performed in a burn-in process by a controller of the hard disk drive.

The at least one head may be a plurality of heads and the at least one disk may be a plurality of disks.

According to another embodiment of the present general inventive concept, there is provided a hard disk drive including at least one disk mapped into a plurality of zones, at least one head to write data to the disk or to read data from the disk, and a controller to measure at least one parameter related to performance of the hard disk drive of each head and each zone, and to set a critical temperature to activate a write-verify function of each head and each zone based on the at least one parameter measured for each head and each zone.

The controller may assign a performance level to each head and each zone according to a predetermined classification with respect to the at least one parameter measured for each head and each zone, and can set the critical temperature corresponding to the performance level of each head and each zone.

The critical temperature may decrease as the performance level increases.

The at least one parameter may include a bit error rate (BER).

The at least one parameter may include read channel optimization (RCO) data.

The at least one parameter may include bits per inch (BPI).

The at least one parameter may be a plurality of parameters, and the plurality of parameters may include at least two of a bit error rate (BER), read channel optimization (RCO) data and bits per inch (BPI).

The at least one head may include a write head and a read head and, in the measuring of at least one parameter for each head and each zone, the performance of the hard disk drive may be a write performance of the write head.

The at least one head may include a write head and a read head and, in the measuring of at least one parameter for each head and each zone, the performance of the hard disk drive may be a write and read performance of the write head and the read head.

The controller may perform the setting of the critical temperature to activate the write-verify function of each head and each zone in a burn-in process.

The at least one head may be a plurality of heads and the at least one disk may be a plurality of disks.

According to another embodiment of the present general inventive concept, there is provided a data storage device, including at least one head to write data to a plurality of zones of at least one storage media, and a controller to measure at least one parameter related to performance of the data storage device with respect to each zone and head, and to activate a write-verify function of the data storage device based on the at least one parameter.

The data storage device may further include a thermistor to measure an internal temperature of the data storage device, wherein the controller can adjust the parameters based on the internal temperature.

The data storage device may further include a user interface to display and/or adjust the parameters.

The parameters can be assigned to a plurality of performance levels to indicate various levels of performance of each zone and/or head at various internal temperatures of the data storage device.

When there are multiple parameters, the parameters can be assigned to the performance levels based on a relevancy of the parameters to the performance of the data storage device.

According to another embodiment of the present general inventive concept, there is provided a method of activating a write-verify function of a data storage device including at least one head to write data to a plurality of zones of a storage media, the method including measuring at least one parameter related to performance of the data storage device with respect to each zone and head, and activating a write-verify function of the data storage device based on the at least one parameter.

The method can further include measuring an internal temperature of the data storage device, and adjusting the parameters based on the internal temperature.

The method can further include assigning the parameters to a plurality of performance levels to indicate various levels of performance of each zone and/or head at various internal temperatures of the data storage device.

When there are multiple parameters, the parameters can be assigned to the performance levels based on a relevancy of the parameters to the performance of the data storage device.

According to another embodiment of the present general inventive concept, there is provided a method of activating a write-verify function of an HDD, including recording at least one performance parameter at various temperatures of the HDD, determining critical temperatures where the performance parameters are substantially changed with respect to a plurality of zones and/or heads of the HDD, and comparing an operating temperature of the HDD with the critical temperatures to determine whether to activate of a write-verify function with respect to each zone and/or head.

### BRIEF DESCRIPTION OF THE DRAWINGS

Exemplary embodiments of the present general inventive concept will become apparent and more readily appreciated from the following description of the example embodiments taken in conjunction with the accompanying drawings of which:

FIG. 1 is a partially exploded perspective view of an HDD employing a method of setting a write-verify temperature according to an exemplary embodiment of the present general inventive concept;

FIG. 2 is a block diagram of a drive circuit of an HDD employing a method of setting a write-verify temperature according to an exemplary embodiment of the present general inventive concept;

FIG. 3 is a flowchart of a method of setting a write-verify temperature according to an exemplary embodiment of the present general inventive concept;

FIG. 4 is a table illustrating an example of BERs measured for each head and each zone;

FIG. 5 is a table illustrating an example of critical temperatures to activate a write-verify function and a performance level with respect to a range of the BER;

FIG. 6 is a table illustrating an example of critical temperatures to activate a write-verify function set for each head and each zone; and

FIG. 7 is a flowchart of a method of activating a write-verify function in accordance with another embodiment of the present general inventive concept.

### DETAILED DESCRIPTION OF THE EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

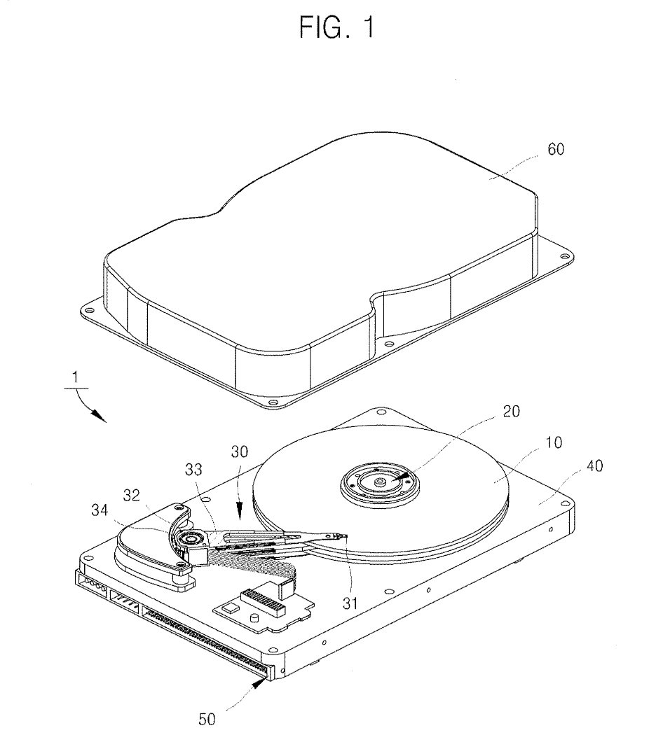

FIG. 1 is a partially exploded perspective view of a hard disk drive (HDD) 1 employing a method of setting a write-verify temperature according to an exemplary embodiment of the present inventive concept. Referring to FIG. 1, the HDD 1 can include at least one disk 10 to record and to store data, a spindle motor (SPM) 20 to support and rotate the disk 10, a head stack assembly (HSA) 30 to record data on the disk 10 or to read data from the disk 10, a base 40 where these elements can be assembled, a printed circuit board assembly (PCBA) 50 coupled to a lower portion of the base 40, the PCBA 50 having a printed circuit board (PCB) on which a plurality of circuit parts can be installed and to control the various parts, and a cover 60 to cover an upper portion of the base 40. In the present embodiment, the HDD 1 can include two disks 10, although more or less disks could also be used without departing from the broader principles and spirit of the present general inventive concept.

The HSA 30 can be implemented in the form of a carriage to record data on the disk 10 or to reproduce the data from the disk 10. The HSA 30 can include at least one head 31 to write data to the disk 10 or to read the recorded data from the disk 10, an actuator arm 33 to pivot across the disk 10 around a pivot shaft 32 acting as a shaft center to allow the head 31 to access the data on the disk 10, a pivot shaft holder 34 to rotatably support the pivot shaft 32 and to which the actuator arm 33 can be coupled, and a bobbin (not illustrated) provided at the opposite side to the actuator arm 33 with respect to the pivot shaft holder 34 and having a voice coil wound around the bobbin to be disposed between magnets (not illustrated) of a voice coil motor (VCM, not illustrated).

In the present embodiment, although it is not illustrated in FIG. 1, the HSA 30 can include three heads. Each of the heads can include a write head to write data to the disk 10 by magnetizing the surface of the disk 10 and a read head to read data from the disk 10 by detecting a magnetic field formed on the surface of the disk 10. However, the present general inventive concept is not limited thereto. It is possible that the HSA 30 may have a number of heads more or less than the three heads. It is also possible that the disk 10 may have more than one disk according to the number of heads.

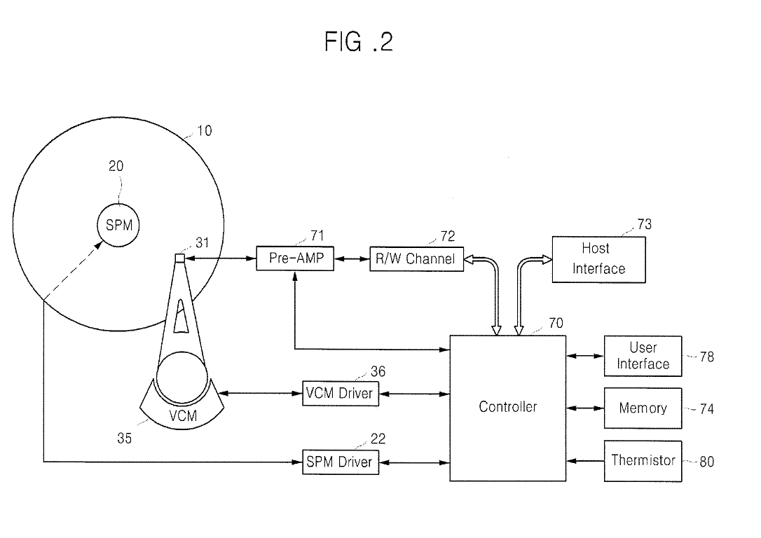

FIG. 2 is a block diagram of a drive circuit of the HDD 1 employing a method of setting a write-verify temperature according to an exemplary embodiment of the present general inventive concept. Referring to FIG. 2, the HDD 1 can include the head 31 to write data to the disk 10 or to read the recorded data from the disk 10 to which data is written using the head 31, an SPM driver 22 to supply drive current to the SPM 20 to control the rotation of the disk 10 by driving the SPM 20, a VCM driver 36 to supply drive current to a voice coil (not shown) to control the movement of the head 31 by driving the VCM, a controller 70 connected to the head 31 via a read/write (R/W) channel 72 and a pre-amplifier 71, and a memory unit 74 in which data and commands by the controller 70 to execute software routine can be stored.

The HDD 1 can include a thermistor 80 as a temperature measurement unit to measure an internal temperature. The thermistor 80 can generate a voltage signal corresponding to the internal temperature of the HDD 1 and can transmit a generated voltage signal to the controller 80.

Since the internal temperature of the HDD 1 can affect the performance or reliability of the HDD 1, the controller 70 can measure the internal temperature of the HDD 1 using the thermistor 80 and can correct various parameters of the HDD 1 according to a result of the measurement to improve performance and reliability of the HDD 1 according to temperature. In particular, in the present embodiment, the internal temperature of the HDD 1 measured by the thermistor 80 can be used in a method of controlling a write operation of the HDD 1 employing the method of setting a write-verify temperature, which will be described in more detail below.

The thermistor 80 can be arranged on a flexible PCB (not illustrated) of the HDD 1. However, the thermistor 80 may be arranged in any area of the HDD 1 to measure the internal temperature of the HDD 1. Information is typically transferred from the R/W channel 72 to a host interface 73. The host interface 73 can include a control circuit to interface with a system such as a personal computer to communicate with the HDD 1.

The R/W channel 72 can convert an analog signal read by the head 31 in a preproduction mode and amplified by the pre-amplifier 71 to a digital signal read by a host computer (not illustrated), and can output a converted signal to the host interface 73. Also, when user data received through the host interface 73 in a write mode is converted so that a write signal is output to the pre-amplifier 71, the pre-amplifier 71 can convert a write signal to a write current to be output through the head 31.

The controller 70 may be a digital signal processor (DSP), a microprocessor, or a microcontroller, and may be embodied by software or firmware. The controller 70 can supply a control signal to the R/W channel 72 to read data from the disk 10 or to write data to the disk 10. Also, the controller 70 can perform an algorithm to set a critical temperature to activate a write-verify function which will be described in more detail below.

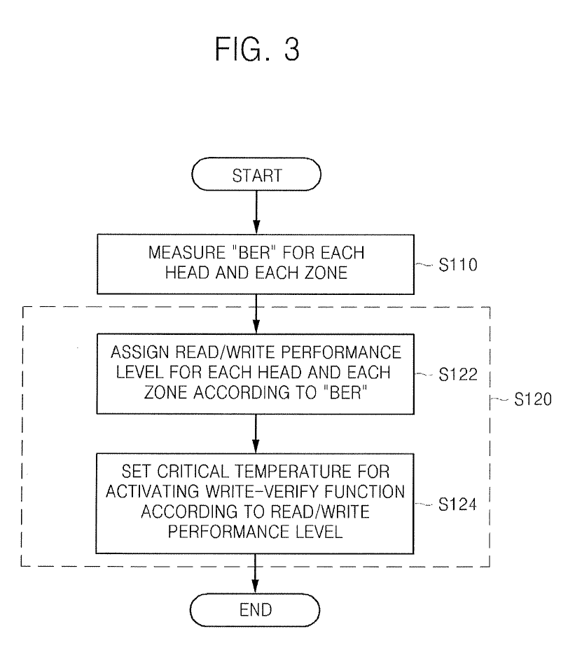

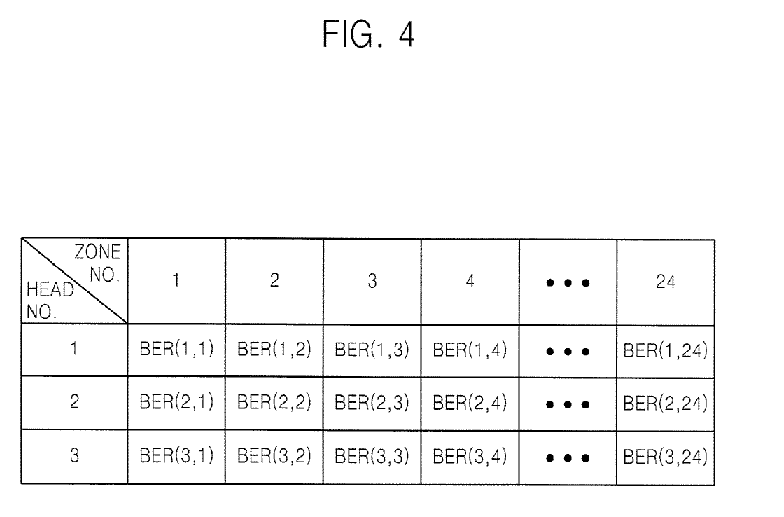

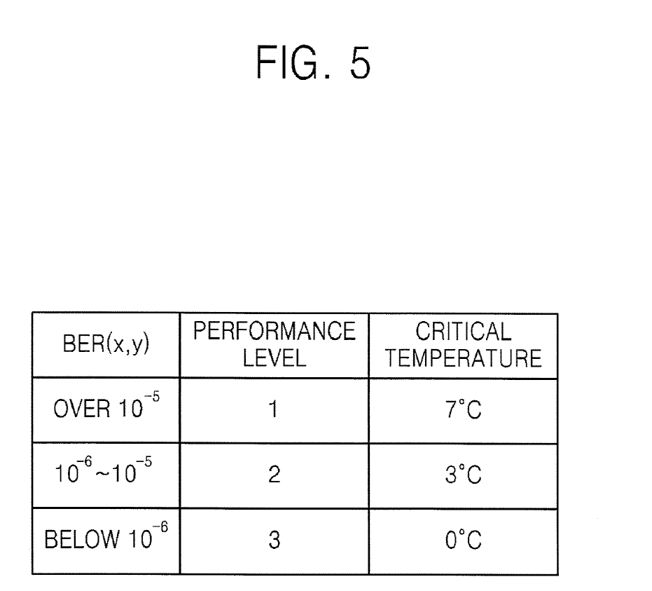

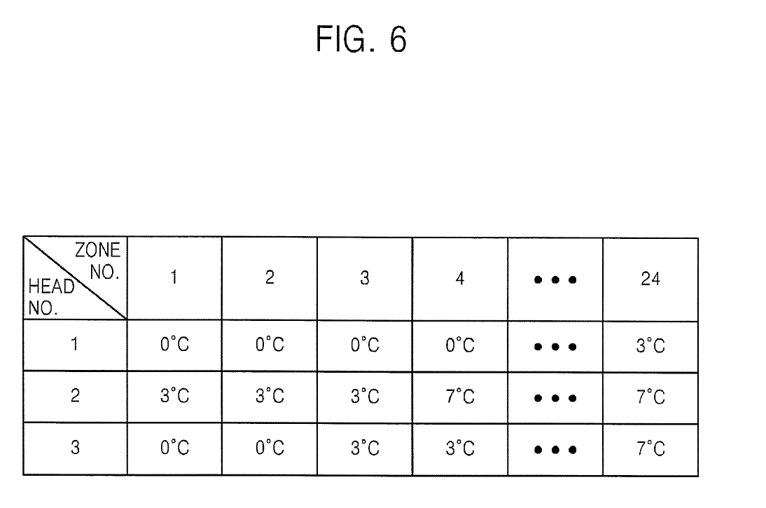

FIG. 3 is a flowchart illustrating a method of setting a write-verify temperature according to an exemplary embodiment of the present inventive concept. FIG. 4 is a table illustrating an example of bit error rates (BERs) measured for each head and each zone. FIG. 5 is a table illustrating an example of critical temperatures to activate a write-verify function and a performance level with respect to a range of the BER. FIG. 6 is a table illustrating an example of critical temperatures to activate a write-verify function set for each head and each zone.

In general, the HDD 1 can be manufactured through a series of a mechanical assembly process, a servo write process, a function test process, a burn-in process, a final test process, and an acceptance process. In the servo write process, a write operation can be performed with respect to the overall surface of the disk 10 at a constant interval to set data position information. In the function test process, it can be determined whether the servo write operation is defective.

The burn-in process, which generally takes the longest time in the manufacturing process of the HDD 1, can be performed by the controller in a burn-in room that is hot and humid without a separate test system. The controller 70 can perform the burn-in process using firmware stored in the memory 74.

In the burn-in process, a defect portion existing on the disk 10 can be found in advance so that the defect portion is processed so as not to be used by a user when using the HDD 1. In doing so, a read channel optimization (RCO) process to control channel parameters according to the intrinsic nature of each of the HDDs that are mass-produced can be performed.

The method of setting a write-verify temperature according to the present embodiment can be performed in a burn-in process by the controller 70 of the HDD 1. In the final test process, it can be determined whether the HDD 1 which passed the burn-in process has been processed without abnormal defects. In the acceptance process, an outer appearance test, noise, and model name can be compared to those stored in a maintenance cylinder (M/C) before packing the HDD 1.

Referring to FIGS. 3-6, the method of setting a write-verify temperature according to an embodiment of the present inventive concept will be described. First, at least one parameter related to the performance of the HDD 1 can be measured for each head and each zone (S110). For example, in the present example embodiment, the at least one parameter related to the performance of the HDD 1 can be the BER (bit error rate), as illustrated in FIGS. 3-5, although many other parameters may also be used to evaluate the performance of the HDD 1, such as read channel optimization (RCO) data, bits per inch (BPI), and the like.

The BER can be a measurement of a read error generation rate with respect to written data by limiting an error correction code (CEE), and can be used as a performance indicator of the disk 10 in the middle of the process. The BER is usually measured at room temperature. However, it is possible that a BER generated at low temperature may be used in the process to consider weak write performance.

FIG. 4 illustrates an example of BERs measured for each head and each zone with respect to the HDD 1, wherein the disk 10 is mapped into three heads and twenty-four zones. When the BER for a head and a zone is expressed as BER(x,y), “x” can signify the number of heads while “y” can signify the number of zones.

The zones can be concentric circles or a set of adjacent tracks located on the disk 10. In general, a zone mapping process to divide the surface of the disk 10 into a plurality of zones can be performed before the RCO process is performed.

A variety of parameters, for example, BER, RCO data, or BPI, related to the performance of the HDD 1 may vary according to each head and disk 10, even for an HDD 1 of the same model, or even for each zone on the disk 10. Also, the RCO process can be performed for each head and each zone. Thus, the performance of the HDD 1 can be estimated differently according to the head and zone.

In detail, the performance of the HDD 1 can signify the read/write performance of the HDD 1. As described above, the head 31 of the HDD 1 can include the write head to write data to the disk 10 and the read head to read data from the disk 10. The write performance can be determined with respect to the write head while the read performance can be determined with respect to the read head.

Since the present general inventive concept is related to the write-verify function, a parameter related to the write performance can be selected among the performance parameters of the HDD 1. That is, in the operation of measuring BER for each head and each zone (S110), the BER can be measured for the write head and each zone. However, since the present general inventive concept is not limited thereto, in the operation S110, parameters may be selected considering both of the recording performance and the reproduction performance to measure BER for the head including both of the write head and the read head and each zone so that reliability of evaluation of performance of each head and each zone may be improved.

The write-verify function is a technology relating to data storage protection, and can be introduced to improve reliability of the HDD 1 and to signify a function of verifying a record on the disk 10. In detail, in the operation of writing data to the disk 10, the write-verify function can repeat write and read operations according to an error rate by receiving a data write command and writing data to the disk 10, reading written data from the disk 10, and comparing the read data with data before the write, when the internal temperature of the HDD 1 measured by the thermistor 80 is not higher than a predetermined critical temperature, for example, 0° C.

In the present embodiment, although the BER can be used as a parameter related to the performance of the HDD 1, that is, a parameter to evaluate the performance of the HDD 1, other parameters such as read channel optimization (RCO) data or bits per inch (BPI) may be used to evaluate the performance of the HDD 1. Furthermore, a plurality of parameters may be selected to evaluate the performance of the HDD 1. For example, a plurality of parameters including at least two of the BER, the RCO data, and the BPI, may be selected. These parameters can be measured for each head and zone at different temperatures or operating conditions to obtain performance results for each head and zone. For example, the parameters can be measured or adjusted during a manufacturing process of the HDD 1, or may be made or adjusted by a user at a later date to obtain optimal performance results under various operating conditions and temperatures, via a user interface 78 of the controller 70 to adjust and/or display the parameters.

The controller 70 may generate a signal through the user interface 78 to display an image of a user interface screen of a display unit so that a user can monitor the performance parameters, or can adjust at least one of the parameters through the user interface screen. It is possible that the user interface 78 can be integrated with the controller 70, or can be provided separately or in combination with other components.

As a method of measuring and defining the read/write performance of the HDD 1, the RCO data or BPI may be measured in addition to the above-described BER. The RCO data can include write current, read current, overshoot control, and flying on demand as optimal channel parameters determined through the above-described RCO process.

In the HDD 1, converting data read from the disk 10 to digital data and converting user data received through the host interface 73 to a write signal can be performed in the R/W channel 72. The effectiveness of the R/W channel 72 in reading an analog signal transferred from the disk 10 via the head 31 can be determined by a variety of channel parameters.

Also, the BPI can correspond to a data rate applied when the head 31 writes data to the disk 10 or reads data from the disk 10. The BPI can be determined through the zone mapping of the HDD 1. The performance of each of the head 31 and the disk 10 are among the major factors in determining the BPI.

A critical temperature to activate the write-verify function can be set for each head and each zone based on the at least one parameter measured for each head and each zone, at operation S120. The operation S120 can include assigning a performance level of each head and each zone according to a predetermined classification with respect to the BER measured for each head and each zone (operation S122) and setting the critical temperature corresponding to the performance level of each head and each zone (operation S124).

Referring to FIG. 5, the performance level can be divided into three sections: Performance Level 1, Performance Level 2, and Performance Level 3. Each performance level can indicate low performance, medium performance, and high performance, respectively. For example, in the operation S122, Performance Level 1 can be assigned to a combination of the head and zone belonging to a range in which a measured BER value exceeds 10⁻⁵, Performance Level 2 can be assigned to a combination of the head and zone belonging to a range in which a measured BER value is 10⁻⁶ through 10⁻⁵, and Performance Level 1 can be assigned to a combination of the head and zone belonging to a range in which a measured BER value is less than 10⁻⁶. These ranges can signify that the read/write performance increases as the BER value decreases.

When there are multiple measured parameters, the performance levels can be assigned in consideration of closeness to the read/write performance of each parameter or relevancy between the parameters.

In the operation S124, the critical temperature can be set to 7° C. for a combination of the head and zone to which Performance Level 1 is assigned. The critical temperature can be set to 3° C. for a combination of the head and zone to which Performance Level 2 is assigned. The critical temperature can be set to 0° C. for a combination of the head and zone to which Performance Level 3 is assigned.

The critical temperature can be a temperature at which the activation of the write-verify function begins in the data write operation. When the internal temperature of the HDD 1 measured by the thermistor 80 is not higher than the critical temperature, write operation can be performed in a state in which the write-verify function is activated. The critical temperature can decrease as the read/write performance increases. Since the combination of the head and zone exhibiting high read/write performance has relatively high reliability on the performance even when the internal temperature of the HDD 1 is low, the write-verify function that may cause deterioration of the performance of the HDD 1 does not need to be activated at a relatively high temperature.

FIG. 6 is a table illustrating an example of critical temperatures to activate a write-verify function set for each head and each zone. Referring to FIG. 6, an example of the critical temperatures set for each head and each zone in the operation S124 is illustrated. The critical temperature set for each head and each zone in the operation S124 can be stored in the memory 74 of the HDD 1 in the form of a table. The table can then be referred to as a reference to activate the write-verify function when the data write operation is performed with respect to the disk 10. However, the performance level section and the critical temperature are not limited to those illustrated in FIG. 5 and may be changed according to the type or quality of the HDD 1, or at the request by a user.

The above-described data corresponding to the performance parameters including at least one of BER, BPI, RCO, critical temperature, and the like can be written in an area of the disk 10, or can be stored in the memory 74 of the HDD 1.

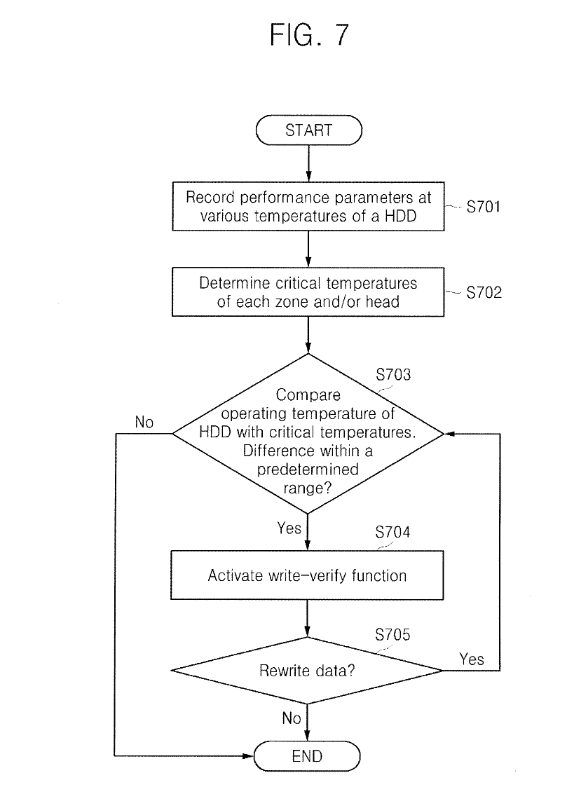

FIG. 7 is a flowchart of a method of activating a write-verify function in accordance with another embodiment of the present general inventive concept. In FIG. 7, performance parameters at various temperatures of the HDD can be recorded at operation S701. The performance parameters can be written in an area of the disk 10 or can be stored in the memory 74 of the HDD during a manufacturing or inspection process of the HDD, and can be recorded or adjusted by a user via the user interface 78 during operation of the HDD (see FIG. 2). At operation S702, the performance parameters recorded at various temperatures can be used to determine critical operating temperatures of each zone and/or head of the HDD indicating where performance of the HDD is changed. At operation S703, the controller can compare the internal operating temperature of the HDD with the critical temperatures to determine if the difference between the temperatures is within a predetermined range. If the temperature difference is within a predetermined range, the write-verify function can be activated at operation S704 to determine whether the data should be re-written at operation S705. If the data is determined to be re-written, operation S703 can be repeated to determine whether to activate the write-verify function until it has been determined that the data has been correctly written.

The write-verify function which can verify data written on the disk 10 may improve reliability of the HDD 1, but may also deteriorate data transfer performance. This is because the write-verify function typically requires a waiting time until a write point is re-read, in order to check whether data is correctly written by re-reading the write point. However, in the method of setting a write-verify temperature according to the present inventive concept, a critical temperature to activate the write-verify function can be set for each head and each zone to control the frequency in which the write-verify function is performed. Thus, while satisfying the reliability in the write operation of the HDD 1, the use of the write-verify function that causes performance deterioration may be minimized.

As described above, according to the present general inventive concept, since a critical temperature to activate the write-verify function can be set for each head and each zone, the write-verify function which may cause deterioration of performance of an HDD may be minimized while satisfying the write operation of the HDD.

The present general inventive concept can also be embodied as computer-readable codes on a computer-readable medium, and can be implemented as program code segments to perform operations necessary to the respective elements of the present general inventive concept. The computer-readable medium can include a computer-readable recording medium and a computer-readable transmission medium. The computer-readable recording medium can be any data storage device that can store data which can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. Also, functional programs, codes, and code segments to accomplish the present general inventive concept can be easily construed by programmers skilled in the art to which the present general inventive concept pertains

Although a few embodiments of the present general inventive concept have been illustrated and described, it will be appreciated by those skilled in the art that changes may be made in these embodiments without departing from the principles and spirit of the general inventive concept, the scope of which is defined in the appended claims and their equivalents.

What is claimed is:

1. A method of setting a write-verify temperature of a hard disk drive having at least one disk mapped into a plurality of zones and at least one head, the method comprising:
measuring at least one parameter related to performance of the hard disk drive for each head and each zone; and
setting a critical temperature to activate a write-verify function of each head and each zone based on the at least one parameter measured for each head and each zone.

2. The method of claim 1, wherein the setting of a critical temperature comprises:
assigning a performance level of each head and each zone according to a predetermined classification with respect to the at least one parameter measured for each head and each zone; and
setting the critical temperature corresponding to the performance level of each head and each zone.

3. The method of claim 2, wherein, in the setting of the critical temperature corresponding to the performance level of each head and each zone, the critical temperature decreases as the performance level increases.

4. The method of claim 1, wherein the at least one parameter comprises a bit error rate (BER).

5. The method of claim 1, wherein the at least one parameter comprises read channel optimization (RCO) data.

6. The method of claim 1, wherein the at least one parameter comprises bits per inch (BPI).

7. The method of claim 1, wherein the at least one parameter is a plurality of parameters, and the plurality of parameters comprises at least two of a bit error rate (BER), read channel optimization (RCO) data and bits per inch (BPI).

8. The method of claim 1, wherein the at least one head comprises a write head and a read head, and in the measuring of at least one parameter of each head and each zone, the performance of the hard disk drive is a write performance of the write head.

9. The method of claim 1, wherein the at least one head comprises a write head and a read head, and in the measuring of at least one parameter of each head and each zone, the performance of the hard disk drive is a write and read performance of the write head and the read head, respectively.

10. The method of claim 1, wherein the method of setting a write-verify temperature of the hard disk is performed in a burn-in process by a controller of the hard disk drive.

11. The method of claim 1, wherein the at least one head comprises a plurality of heads and the at least one disk comprises a plurality of disks.

12. A hard disk drive comprising:
at least one disk mapped into a plurality of zones;
at least one head to write data to the disk or to read data from the disk; and
a controller to measure at least one parameter related to performance of the hard disk drive of each head and each zone, and to set a critical temperature to activate a write-verify function of each head and each zone based on the at least one parameter measured for each head and each zone.

13. The hard disk drive of claim 12, wherein the controller assigns a performance level to each head and each zone according to predetermined classification with respect to the at least one parameter measured for each head and each zone, and sets the critical temperature corresponding to the performance level of each head and each zone.

14. The hard disk drive of claim 12, wherein the at least one parameter comprises a bit error rate (BER).

15. The hard disk drive of claim 12, wherein the at least one parameter comprises read channel optimization (RCO) data.

16. The hard disk drive of claim 12, wherein the at least one parameter comprises bits per inch (BPI).

17. The hard disk drive of claim 12, wherein the at least one parameter is a plurality of parameters, and the plurality of parameters comprises at least two of a bit error rate (BER), read channel optimization (RCO) data and bits per inch (BPI).

18. The hard disk drive of claim 12, wherein the at least one head comprises a write head and a read head, and in the measuring of at least one parameter of each head and each zone, the performance of the hard disk drive is a write performance of the write head.

19. The hard disk drive of claim 12, wherein the at least one head comprises a write head and a read head, and in the measuring of at least one parameter of each head and each zone, the performance of the hard disk drive is a write and read performance of the write head and the read head, respectively.

20. A data storage device, comprising:
at least one head to write data to a plurality of zones of at least one storage media; and
a controller to measure at least one parameter related to performance of the data storage device with respect to each zone and head, and to activate a write-verify function of the data storage device based on the at least one parameter.

21. The data storage device of claim 20, further comprising:
a thermistor to measure an internal temperature of the data storage device, wherein the controller adjusts the parameters based on the internal temperature.

22. The data storage device of claim 20, wherein the parameters are assigned to a plurality of performance levels to indicate various levels of performance of each zone and/or head at various internal temperatures of the data storage device.

23. The data storage device of claim 22, wherein when there are multiple parameters, the parameters are assigned to the performance levels based on a relevancy of the parameters to the performance of the data storage device.

24. A method of activating a write-verify function of a data storage device including at least one head to write data to a plurality of zones of a storage media, the method comprising:
measuring at least one parameter related to performance of the data storage device with respect to each zone and head; and
activating a write-verify function of the data storage device based on the at least one parameter.

25. The method of claim 24, further comprising:
measuring an internal temperature of the data storage device; and
adjusting the parameters based on the internal temperature.

26. The method of claim 24, further comprising:
assigning the parameters to a plurality of performance levels to indicate various levels of performance of each zone and/or head at various internal temperatures of the data storage device.

27. The method of claim 26, wherein when there are multiple parameters, the parameters are assigned to the performance levels based on a relevancy of the parameters to the performance of the data storage device.

28. A method of activating a write-verify function of an HDD, the method comprising:
recording at least one performance parameter at various temperatures of the HDD;
determining critical temperatures where the performance parameters are substantially changed with respect to a plurality of zones and/or heads of the HDD; and
comparing an operating temperature of the HDD with the critical temperatures to determine whether to activate of a write-verify function with respect to each zone and/or head.
